(19) United States
(12) Patent Application Publication
(10) Pub. No.: US 2014/0289003 A1
(43) Pub. Date: Sep. 25, 2014

(54) METHODS AND SYSTEMS FOR DETECTING ANOMALY IN PASSENGER FLOW

(71) Applicant: AMADEUS S.A.S., Sophia Antipolis (FR)

(72) Inventors: Philippe Losco, Mouans Sartoux (FR); Marcos Rodriguez Palacios, Peymeinade (FR); Fabienne Dubos, Le Bar sur Loup (FR); Jose Morales Aragon, Nice (FR)

(73) Assignee: Amadeus S.A.S., Sophia Antipolis (FR)

(21) Appl. No.: 13/849,836

(22) Filed: Mar. 25, 2013

(51) Int. Cl. G06Q 50/30; G06Q 10/04

(52) U.S. Cl. CPC G06Q 50/30; G06Q 10/04
USPC 705/7.31

(57) ABSTRACT

Methods and systems for detecting an anomaly in a passenger flow towards a transport device. Historical data relating to the passenger flow is aggregated and a forecast passenger flow value for a target time frame is determined based upon the historical data. A first forecast is computed based upon the passenger flow in a first set of the time frames directly preceding the target time frame. A second forecast is computed based upon the passenger flow in a second set of the time frames, the second set of time frames having occurred on a same weekday and at a same time as the target time frame, in weeks preceding the target time frame. The first and second forecasts are combined to produce the forecast passenger flow value for the target time frame.

### BACKGROUND

The present invention relates to methods and systems for detecting an anomaly in a passenger flow towards a transport device.

Airplane departure delays are highly undesirable as such delays add to airline companies' costs and lead to passenger inconvenience. To achieve on-time flight departures, an airline company may use various processes that may include passenger management. To manage passengers, the airline company may use a passenger management application. The passenger management application may assist the airline passengers from check-in through departure. In addition, the passenger management application may keep a track of the passengers relative to various locations such, a check-in point, a security point, and a boarding point. The airline staff can use the tracking information, for example, to contact and assemble a passenger in case of any delay on the passenger part. The current states of art passenger management applications are not configured to anticipate delays due to the passengers. The current passenger management applications do not utilize passenger flow information to determine delays. Delay in departure of the flight due to one or more passengers may have a direct impact on the passenger, airline and the passenger management applications. The delay may cause wastage of time to the passengers, delays in subsequent flights, loss of revenue to the airline companies and degradation in service experience to the passengers.

Improved methods and systems are needed for detecting anomalies in a passenger flow towards a transport device.

### BRIEF SUMMARY

Embodiments of the present invention provide methods and systems for rapidly detecting an anomaly in a passenger flow towards a transport device, such that departure delays may be avoided or anticipated.

In one embodiment, a method is provided for detecting anomalies in a passenger flow towards a transport device, wherein the passenger flow is a number of passengers being handled at a given location (for example, upon check-in or upon boarding) per time frame of N minutes. The transport device may be an airplane, a train, a bus, a ferry, and the like, in particular any transport device that runs according to a schedule. The method comprises the steps of aggregating historical data relating to the passenger flow and determining a forecast passenger flow value for a target time frame on the basis of the historical data. In particular, the forecast passenger flow value is determined by computing a first forecast on the basis of the passenger flow in a first set of the time frames directly preceding the target time frame, computing a second forecast on the basis of the passenger flow in a second set of the time frames, the second set of time frames having occurred on a same weekday and at a same time as the target time frame, in weeks preceding the target time frame, and combining the first and second forecasts.

It has been found that in order to obtain a forecast rapidly and yet with a satisfactory degree of reliability, a combination of such two types of forecasts may be desirable, namely the first forecast computed on the basis of the directly preceding time frames and the second forecast computed on the basis of each time the same time frame of the weeks before.

According to an embodiment of the invention, the passenger flow is considered in blocks of N minutes, with N being preferably at least 1 (60 seconds) and at most 10 (600 seconds), such that anomalies can be detected rapidly. This is not possible with prior art processes in which passenger flows are considered on, for example, a per hour basis. A larger N means that the data which is started from can be more stable but that it takes longer before the anomaly is detected. A smaller N means that the data which is started from can be more unstable but that the anomaly can be detected sooner. Embodiments of the invention can be particularly advantageous in applications for monitoring passenger flows at check-in desks (acceptance) and at boarding locations on airports, since airplane departure delays are highly undesirable.

The first set of time frames may comprise three or more time frames that are directly preceding the target time frame. The first forecast may be computed as a rolling moving average of the passenger flow in the three or more time frames of the first set. The rolling moving average of the passenger flow provides a smooth forecast that linearly decreases or increases.

The second set of time frames may comprise three or more time frames that have occurred on the same weekday and at the same time as the target time frame in the weeks preceding the target time frame. The second forecast is computed by exponential smoothing of the passenger flow in the at least three time frames of the second set. The exponential smoothing considers a trend factor in calculation of the forecast.

The exponential smoothing may comprise double exponential smoothing. The double exponential smoothing works well with the time frames having passenger flow data comprising trends.

The exponential smoothing may comprise Holt-Winters double exponential smoothing. The Holt-Winters double exponential smoothing adapts to changes in trends and provides a forecast that is reactive to changes.

The combination may comprise computing a relative error for the first and second forecasts and keeping the forecast with the smaller relative error. Keeping the forecast with the smaller relative error allows the forecast be reactive to the recovery and less sensitive to a potential defect.

The method may comprise raising an alarm if the forecast passenger flow value differs by more than a predetermined threshold from an actual passenger flow in the target time frame. The difference of the forecast passenger flow value by more than the predetermined threshold from the actual passenger flow may indicate an anomaly or an error. The predetermined threshold may be within a range of 30% to 50%.

The alarm may not be raised if the actual passenger flow in the target time frame is below a given minimum. The actual passenger flow in the target time frame being below a given minimum indicates an error in forecasting. In one embodiment, the alarm is only raised if the predetermined threshold is exceeded for a number of consecutive time frames. This reduces false alarms, thereby increasing the reliability of the proposed method. The alarm may be raised to indicate the presence of errors reaching a defined number.

According to an embodiment of the invention, a system is provided for detecting an anomaly in a passenger flow towards a transport means, wherein the passenger flow is a number of passengers being handled at a given location per time frame of N minutes. The system comprising an aggregation mechanism configured for aggregating historical data relating to the passenger flow. The system also includes a forecasting mechanism configured for determining a forecast passenger flow value for a target time frame on the basis of the historical data; characterised in that the forecasting mechanism is configured for computing a first forecast on the basis of the passenger flow in a first set of the time frames directly preceding the target time frame, computing a second forecast on the basis of the passenger flow in a second set of the time frames, the second set of time frames having occurred on a same weekday and at a same time as the target time frame, in weeks preceding the target time frame, and determining forecast passenger flow value for the target time frame by combining the first and second forecasts.

It has been found that in order to obtain a forecast rapidly and yet with a satisfactory degree of reliability, a combination of such two types of forecasts may be desirable, namely the first forecast computed on the basis of the directly preceding time frames and the second forecast computed on the basis of each time the same time frame of the weeks before.

The passenger flow may be considered in blocks of N minutes, with N being preferably at least 1 (60 seconds) and at most 10 (600 seconds), such that anomalies can be detected rapidly. This is not possible with prior art processes in which passenger flows are considered on for example a per hour basis. A larger N means that the data which is started from can be more stable but that it takes longer before the anomaly is detected. A smaller N means that the data which is started from can be more unstable but that the anomaly can be detected sooner. Embodiments of the invention can be particularly advantageous in applications for monitoring passenger flows at check-in desks (acceptance) and at boarding locations on airports, since airplane departure delays are highly undesirable.

The first set of time frames may comprise three or more time frames that are directly preceding the target time frame. The first forecast is computed as a rolling moving average of the passenger flow in the three or more time frames of the first set. The rolling moving average of the passenger flow provides a smooth forecast that linearly decreases or increases.

The second set of time frames may comprise three or more time frames that have occurred on the same weekday and at the same time as the target time frame in the weeks preceding the target time frame. The second forecast is computed by exponential smoothing of the passenger flow in the at least three time frames of the second set. The exponential smoothing considers a trend factor in calculation of the forecast.

The exponential smoothing may comprise double exponential smoothing. The double exponential smoothing works well with the time frames having passenger flow data comprising trends.

The exponential smoothing may comprise Holt-Winters double exponential smoothing. The Holt-Winters double exponential smoothing adapts to changes in trends and provides a forecast that is reactive to changes.

The forecasting mechanism may be configured to determine the forecast passenger flow value by computing a relative error for the first and second forecasts and keeping the forecast with the smaller relative error. Keeping the forecast with the smaller relative error allows the forecast be reactive to the recovery and less sensitive to a potential defect.

The system may comprise an alarming mechanism configured for raising an alarm if the forecast passenger flow value differs by more than a predetermined threshold from an actual passenger flow in the target time frame. The difference of the forecast passenger flow value by more than the predetermined threshold from the actual passenger flow may indicate an anomaly or an error. The predetermined threshold may be within a range of 30% to 50%.

The alarm may not be raised if the actual passenger flow in the target time frame is below a given minimum. The actual passenger flow in the target time frame being below a given minimum indicates an error in forecasting. In one embodiment, the alarm is only raised if the predetermined threshold is exceeded for a number of consecutive time frames. The alarm may be raised to indicate the presence of errors reaching a defined number.

### BRIEF DESCRIPTION OF THE SEVERAL VIEWS OF THE DRAWINGS

The invention will be further elucidated by means of the following description and the appended figures.

FIG. 1 shows a system that detects an anomaly in a passenger flow towards a transport device, according to an embodiment of the present disclosure.

FIG. 2 shows an exemplary forecasting engine, according to an embodiment of the present disclosure.

FIG. 3 shows an exemplary monitoring unit, according to an embodiment of the present disclosure.

FIG. 4 shows a plot of relative error versus time generated as a result of moving average technique, according to an embodiment of the present disclosure.

FIG. 5 shows a plot of relative error for various values of data smoothing factor (α) and trend smoothing factor (γ), according to an embodiment of the present disclosure.

FIG. 6 shows a plot of relative error versus time generated as a result of Holt-Winters double exponential smoothing technique, according to an embodiment of the present disclosure.

FIG. 7 shows a plot of relative error versus time without relative errors below 50%, according to an embodiment of the present disclosure.

FIG. 8 shows a plot of relative error versus time as a result of application of latency and reduction in threshold to 40%, according to an embodiment of the present disclosure.

FIG. 9 shows a plot of relative error versus time as a result of application of latency and reduction in threshold to 30%, according to an embodiment of the present disclosure.

FIG. 10 shows a plot of forecasts for passenger flows for time frames, according to an embodiment of the present disclosure.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

Furthermore, the various embodiments, although referred to as “preferred” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present invention, the only enumerated components of the device are A and B, and further the claim should be interpreted as including equivalents of those components.

Referring to FIG. 1, a system 100 detects an anomaly in a passenger flow towards a transport device. The passenger flow as described herein may refer to a number of passengers being handled at a given location per time frame of ‘N’ minutes, wherein N may be but does not have to be a whole number. The system 100 includes a forecasting engine 102, a monitoring unit 104, a passenger flow database 106 and a passenger management application 108.

The forecasting engine 102 computes a forecast passenger flow value for a target time frame on the basis of a historical data. The historical data may include records of passenger flow at a given location, at a given month/week/day, at a given hour, and so forth. The forecasting engine 102 may compute the forecast passenger flow value using one or more forecasting techniques. The forecasting engine 102 may utilize passenger flow information in time frames not having trends or comprising trends or a combination of both to compute the forecast passenger flow value. The forecasting engine 102 may use techniques such as, for example, moving average technique, weighted average technique, double exponential smoothing technique, Holt-Winters double exponential smoothing technique, combination of the aforementioned techniques or any other technique suitable for computing the forecast passenger flow value.

The monitoring unit 104 receives the forecast passenger flow value from the forecasting engine 102. The monitoring unit 104 monitors actual passenger flow in the target time frame. The monitoring unit 104 compares the forecast passenger flow value with the actual passenger flow for the target time frame. In response to detection of the forecast passenger flow value differing by more than a predetermined threshold from the actual passenger flow, the monitoring unit 104 may generate an alarm. In an embodiment, the monitoring unit 104 may be capable of detecting an anomaly and/or an error in a process of comparison. The monitoring unit 104 may raise an alarm in response detection of the anomaly.

The forecasting engine 102 may retrieve the historical data from the passenger flow database 106. The passenger flow database 106 aggregates the historical data relating to the passenger flow. The passenger flow database 106 receives the passenger flow information from the passenger management application 108. The passenger flow database 106 may group and aggregate the passenger flow data per interval equivalent to duration of time frame. For example, the passenger flow database 106 may aggregate the passenger flow data per interval of N minutes, e.g. 5 minutes. Alternatively, the passenger flow database 106 may aggregate the passenger flow data in any other interval or without any interval. The passenger flow database 106 may also consider daylight saving time while aggregating and may realign the aggregate according to a reference time.

The passenger management application 108 manages the passenger flow process in the system 100. An example of the passenger management application 108 includes a passenger departure control system that assists passengers and airline staff from check-in to departure including baggage management, boarding management, and the like.

The forecasting engine 102 and the monitoring unit 104, each may be a standalone application or a modular application (for example, a plugin) that can be integrated with other applications such as the passenger management application 108. In an embodiment, the forecasting engine 102 and the monitoring unit 104 may be a part of the passenger management application 108. The forecasting engine 102 and the monitoring unit 104 may communicate with each other and other applications through, for example, Application Programming Interfaces (API).

The forecasting engine 102, the monitoring unit 104, and/or the passenger management application 108 may be a computer-based system such as, for example, a server, any suitable personal computer, or the like. In another embodiment, the forecasting engine 102, the monitoring unit 104, and/or the passenger management application 108 may be application components that can be implemented in other computer-based systems. The forecasting engine 102, the monitoring unit 104, and/or the passenger management application 108 may be components made of hardware, software, or hardware and software that can be implemented in or in conjunction with the computer-based systems. Those skilled in art can appreciate that computer-based system includes an operating system and various support software associated with server/computer. The forecasting engine 102, the monitoring unit 104, and/or the passenger management application 108 as described herein may be deployed by an organization, such as, a company managing the transport device and/or a third-party associated with the organization.

The forecasting engine 102, the monitoring unit 104, and/or the passenger management application 108 may be implemented as a set of computer related instructions that when loaded onto a computing device produces a machine, for implementing the functions described herein. These computer program instructions may also be stored in a computer-readable memory that can direct a computer or other programmable data processing apparatus to function in a manner described.

The passenger flow database 106 may be any type of database, such as relational, hierarchical, graphical, object-oriented, and/or other database configurations. The forecasting engine 102, the monitoring unit 104, the passenger flow database 106 and the passenger management application 108 may be communicate with each other through a network. Network as discussed may a wide area network (WAN), a local area network (LAN), an Ethernet, Internet, an Intranet, a cellular network, a satellite network, or any other suitable network for communication.

The system 100 as described herein may be implemented for monitoring passenger flows at airports, bus stations, railway stations, shipping yards and the like. The system 100 is particularly useful in applications for monitoring passenger flows at check-in desks (acceptance) and at boarding locations on airports, since airplane departure delays are undesirable.

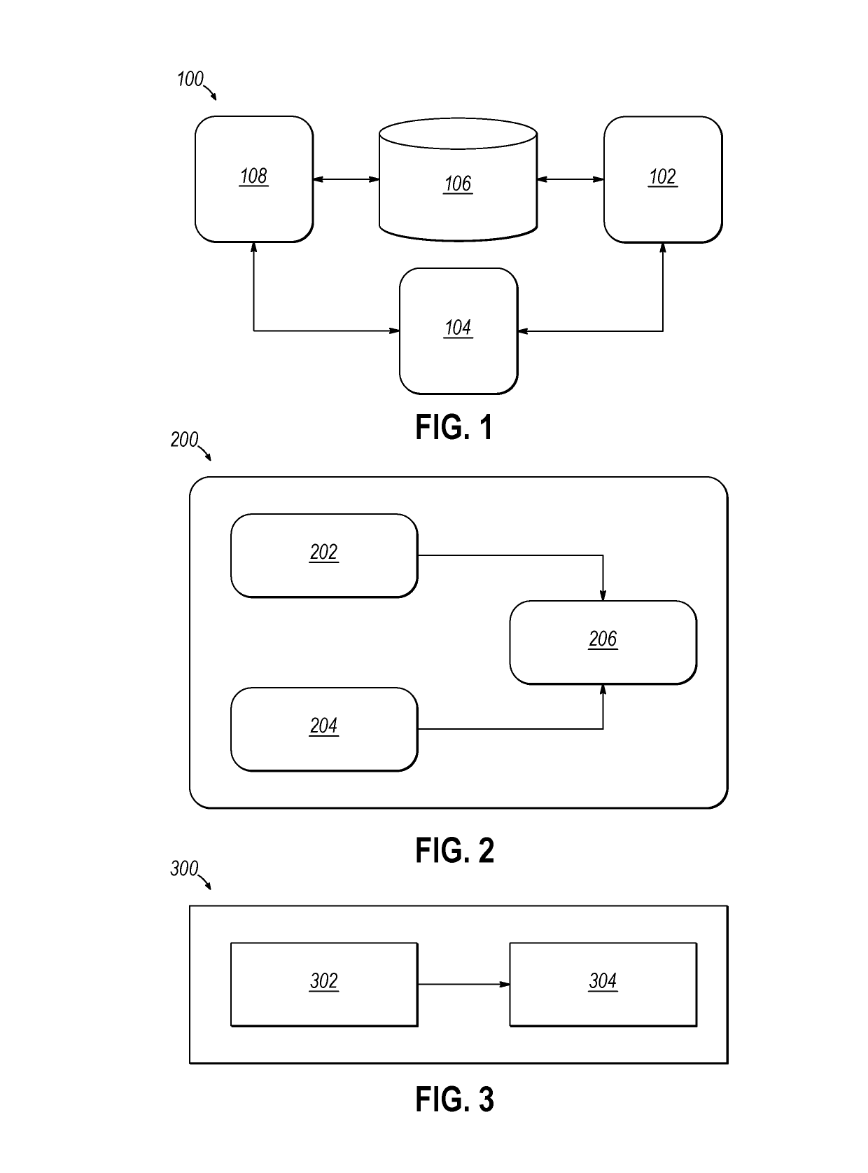

FIG. 2 is an exemplary forecasting engine 200, in accordance with an embodiment of the present disclosure. The forecasting engine 200 generates the forecast passenger flow value based on passenger flow information in time frames from the historical data. Length of the time frame is a design parameter and may be set depending upon requirements of the organization implementing the system 100. For example, a longer time frame results in a more stable forecasted passenger flow value. On the other hand, a shorter time frame allows the forecasted passenger flow value to follow actual passenger flow values more quickly. In an embodiment, the minimum duration N of a time frame may be one (1) minute or sixty (60) seconds. The maximum length N of the time frame may be ten (10) minutes or six hundred (600) seconds. In an embodiment, the time frame may be set to five (5) minutes. Alternatively, time frames can be defined in seconds, hours or any other time unit.

The forecasting engine 200 includes a first forecast module 202, a second forecast module 204, and a processing module 206. The first forecast module 202 computes a first forecast on the basis of the passenger flow in a set of time frames directly preceding the target time frame. In an embodiment, the first forecast module 202 may consider time frames closer to the target time frame as there is less likelihood of trend in the passenger flow. In an embodiment, the first forecast module 202 utilizes a moving average technique to compute the first forecast. For example, the first forecast module 202 may utilize passenger flow information in three time frames directly preceding the target time frame to compute the forecast. Alternatively, the first forecast module 202 may also consider more than three time frames for computing the forecast. For a given time frame ‘t’ and week ‘w₁’, the first forecast ŷ_{w}_{₁ₜ} based on moving average technique can be computed as:

ŷ_{w}_{₁ₜ}=Σy_{w}_{₁}ₜ₋ₙ/n

where ‘n’ is total number of frames and y_{w}_{₁}ₜ is passenger flow at a corresponding the time frame. For a time frame ‘t’ and week ‘w₁’, the forecast ŷ_{w}_{₁ₜ} based on three time frames directly preceding the target time frame is given by:

$${\hat{y}}_{{w}_{1 t}} = \frac{{y}_{{w}_{1} t - 1} + {y}_{{w}_{1} t - 2} + {y}_{{w}_{1} t - 3}}{3}$$

where y_{w}_{₁}ₜ₋₁ is passenger flow value at time frame ‘t−1’; y_{w}_{₁}ₜ₋₂ is passenger flow value at time frame ‘t−2’; and y_{w}_{ₜ}ₜ₋₃ is passenger flow value at time frame ‘t−3’.

The first forecast module 202 may also compute the first forecast using an alternate technique such as weighted average technique, where weightage provided to time frames closer to the target time frame may be comparatively more than a weightage provided to time frames farther to the target time frame. In another alternative, the first forecast module 202 may compute the first forecast using a double exponential smoothing technique. Other alternative techniques for computing the forecast are also contemplated herein.

The second forecast module 204 may compute a second forecast on the basis of the passenger flow in a set of time frames having occurred on a same weekday and at a same time as the target time frame, in weeks preceding the target time frame. In an example, the set of time frames may include three or more time frames having occurred on a same weekday and at a same time as the target time frame, in weeks preceding the target time frame. The second forecast module 204 may consider trends in the passenger flow data. The time frames representing the same time and the same day of the week as the target time frame, in weeks preceding the target time frame may show a trend. The second forecast module 204 may utilize the trend factor in calculation of the second forecast. In an embodiment, the second forecast module 204 utilizes a double exponential smoothing technique. For a given pair time frame ‘t’ and week ‘w₁’, the double exponential smoothing is provided by:

$${b}_{{w}_{1} t} = 2 {L}_{1 {w}_{1} t} - {L}_{2 {w}_{1} t}$$

$${a}_{{w}_{1} t} = \frac{∝}{1 - ∝} ( {L}_{1 {w}_{1} t} - {L}_{2 {w}_{1} t} )$$

$${\hat{y}}_{{w}_{1} t} = {a}_{w - 1 , t} - {b}_{w - 1 , t}$$

where ‘L₁ₜ’ is the first exponential smoothing and ‘L₂ₜ’ is the second exponential smoothing, ‘a_{w}_{₁}ₜ’ is an estimated level and ‘b_{w}_{₁}ₜ’ is an estimated trend at time ‘t’. Parameter ‘α’ is a data smoothing factor. The second forecast module 204 may use a general case of the double exponential smoothing such as a Holt-Winters exponential smoothing technique to generate forecast. Other exponential smoothing techniques may also be used to compute the second forecast. The second forecast module 204 may apply two (2) simple exponential smoothing. The second forecast module 204 may consider an integer ‘γ’ with value between 0 and 1. The parameter ‘γ’ is a trend smoothing factor. ‘γ’ and ‘γ−1’ may represent a weight of the barycentre of the two computed values. The estimated value is computed for a given pair timeframe t and week w by:

b_{w}_{₁}ₜ=αy_{w}_{₁}ₜ+(1−α)(b_{w-1,t}+a_{w-1,t})

a_{w}_{₁}ₜ=γ(b_{w}_{₁}ₜ+b_{w-1,t})+(1−γ)a_{w-1,t}

ŷ_{w}_{₁}ₜ=a_{w-1,t}−b_{w-1,t}

The second forecast module 204 may compute the parameters ‘α’ and ‘γ’ to adapt the algorithm to the data. For example, these parameters may be set according to the airline, the airport, season of the year and/or other suitable factors.

The processing module 206 may combine the forecasts generated by the first forecast module 202 and the second forecast module 204 to generate the forecast passenger flow value for the target time frame. In one example, the processing module 206 may compute a relative error for the first and the second forecast passenger flow value and keep the forecast with the smaller relative error. Although an example for combining the forecasts is provided, one should appreciate that other techniques to combine the forecasts are contemplated herein.

FIG. 3 is an exemplary monitoring unit 300, in accordance with an embodiment of the present disclosure. FIG. 3 includes a compare module 302, and a notification module 304.

The compare module 302 receives the forecast passenger flow value from the forecasting engine 102 for a given target time frame. The compare module 302 also receives the actual passenger flow from the passenger management application 108 for the target time frame. The compare module 302 compares the forecast passenger flow value with the actual passenger flow for the target time frame. The compare module 302 may determine a presence of an anomaly or an error when the forecast passenger flow value differs by more than a predetermined threshold from the actual passenger flow in the target time frame. The predetermined threshold may be defined in terms of percentage. The compare module 302 may determine the presence of the anomaly when percentage of the forecast passenger flow value is lesser than the predetermined threshold from the actual passenger flow. The compare module 302 may determine the presence of an error when the actual passenger flow is given below a minimum.

In response to detection of the anomaly, the notification module 304 generates an alarm. For example, if the actual passenger flow is greater than the predetermined threshold from the forecast passenger flow value passenger flow, the compare module 302 may cause an alarm. In an example, the predetermined threshold may be set within a range of 30% to 50% from the actual passenger flow. In other examples, the predetermined threshold may be customized to other values. The notification module 304 may communicate the notifications indicating anomaly in the passenger flow towards a transport device. The alarm may be a visual alarm, an audible alarm, a message, an email, a pop-up on a user interface and the like.

In some embodiments, the compare module 302 may include a mechanism where when the forecast passenger flow value is below a given minimum, the compare module 302 may ignore such forecast passenger flow values. In such cases, no alarm is generated even if the difference between the forecast passenger flow value and the actual passenger flow value is greater than the predetermined threshold. This mechanism reduces false alarms caused due to low base value when computing the percentage difference. In further embodiments, the notification module 304 may generate an alarm only when the difference between the forecast passenger flow value and the actual passenger flow values exceed the predetermined threshold for a number of consecutive time frames. This further improves the robustness of the system 100 and reduces chances of false alarms.

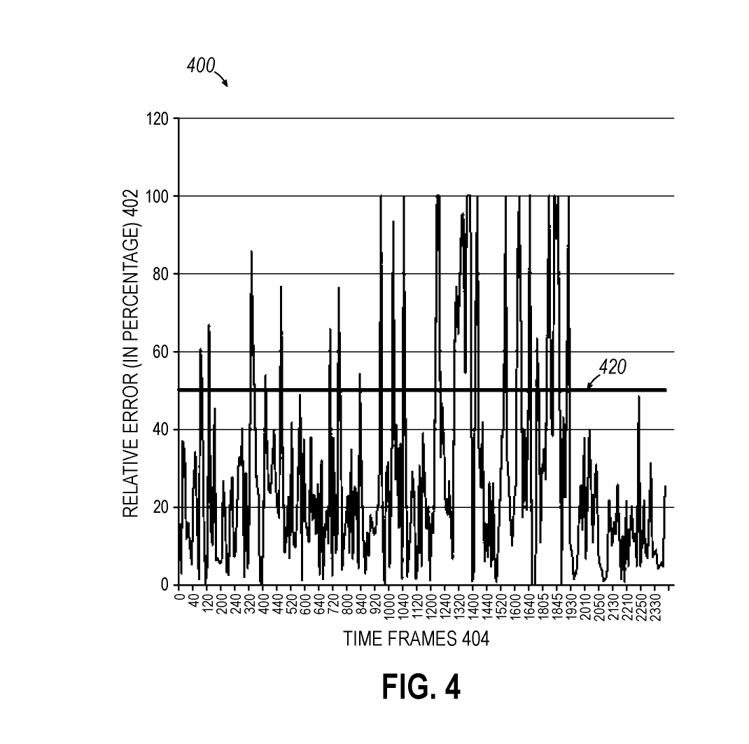

FIGS. 4-10 describe an example anomaly detection process in passenger management for an airline in an airport, in accordance with an embodiment of the present disclosure. In the current example, passenger flows at boarding are considered. The techniques are equally applicable to monitor passenger flows at check-in. The forecasting engine 102 computes two forecasts. The forecasting engine 102 computes a first forecast using time frames directly preceding the target time frame. The forecasting engine 102 computes the second forecast using passenger flow in time frames having occurred on a same weekday and at a same time as the target time frame, in weeks preceding the target time frame. The forecasting engine 102 also generates the forecast passenger flow value by combining the first forecast and the second forecast. The monitoring unit 104 evaluates the combined forecasts using the actual passenger flow at the target time and generates alarms appropriately.

In an example, the forecasting engine 102 may use a rolling moving average technique to compute the first forecast for the target time using passenger flow data in the three time frames directly preceding the target time frame. The monitoring unit 104 may compare the actual passenger flow with the first forecast at the target time frame. Frame size is 5 minutes in the current example. A plot 400 of the relative error versus time is illustrated in FIG. 4. FIG. 4 shows the relative error 402 (in percentage) due to the first forecast at different time frames (404). The predetermined threshold 420 (50% in this example) is also shown. As seen in FIG. 4, there are multiple instances where the relative error due to the first forecast exceeds the predetermined threshold of 50%. Such instances may raise likelihood of false alarms.

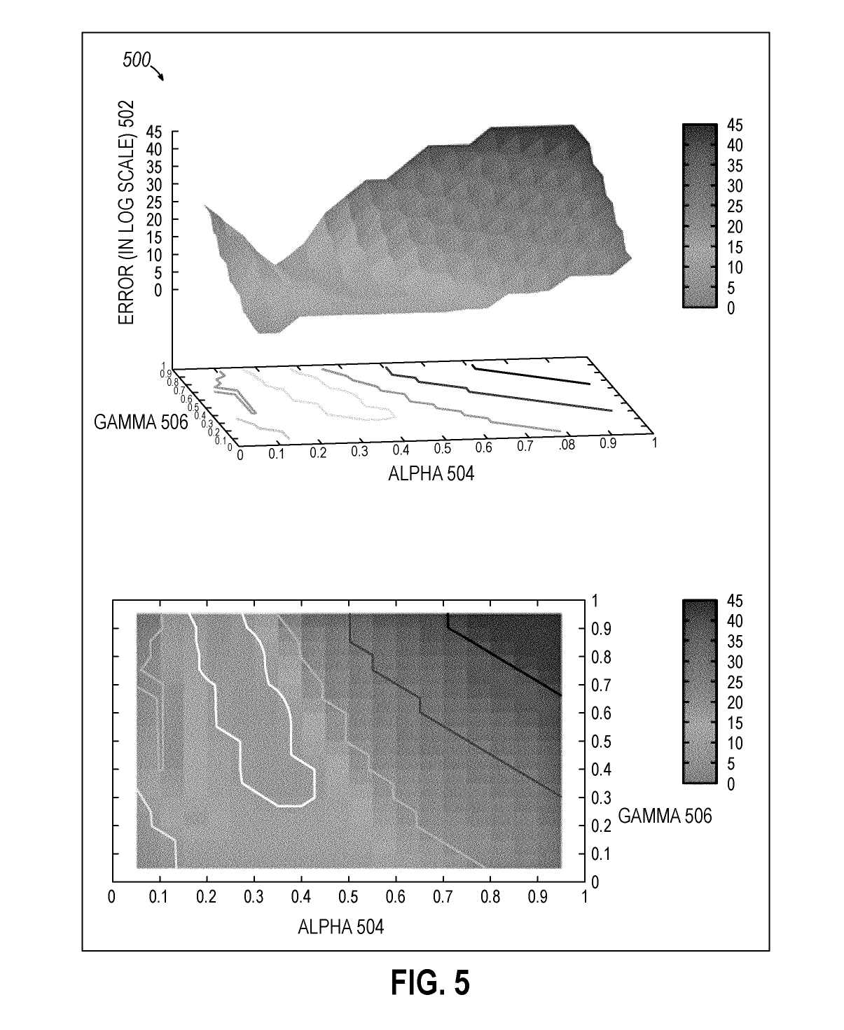

The forecasting engine 102 may use a Holt-Winters double exponential technique to compute the second forecast for the target time using passenger flow in time frames having occurred on a same weekday and at a same time as the target time frame, in weeks preceding the target time frame. Historical data for one year preceding the target time frame may be considered for computing the second forecast. The forecasting engine 102 may compute the alpha (α) and gamma (γ) of equation 4 to generate the second forecast. The second forecast module 204 may choose a pair alpha (α) and gamma (γ) that minimizes a relative error between the computed second forecast and the actual passenger values. FIG. 5 shows a plot 500 illustrating relative error values (502) for different values of alpha (504) and gamma (506).

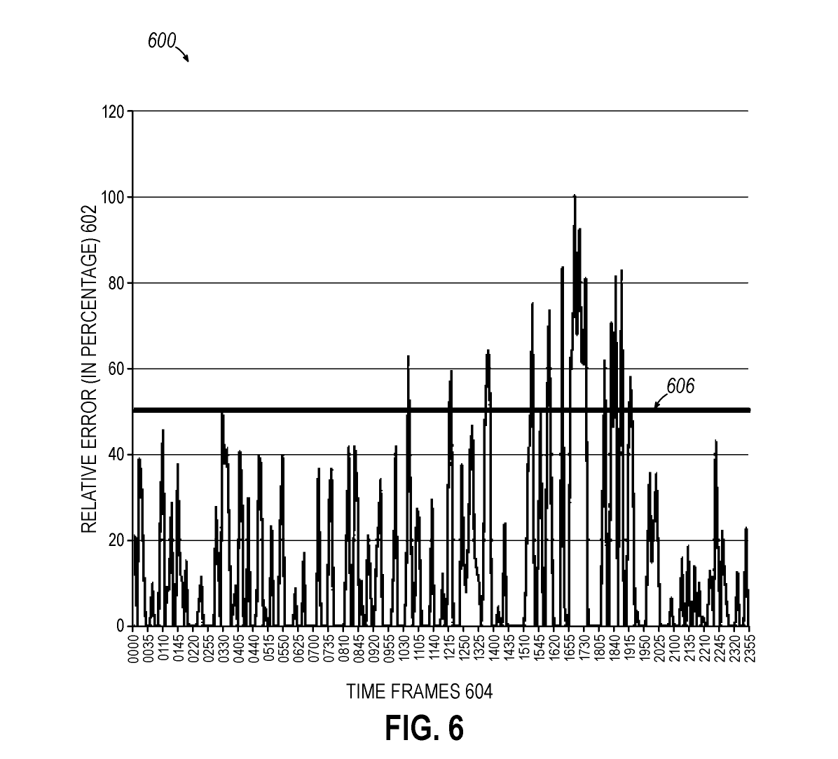

A plot 600 of FIG. 6 illustrates relative error values (602, represented in percentage) of the second forecast from the actual passenger flow at different time frames (604). The predetermined threshold 606 was kept at 50%. While reducing the number of false alarms as compared to the first forecast, there were still a few instances of false alarms.

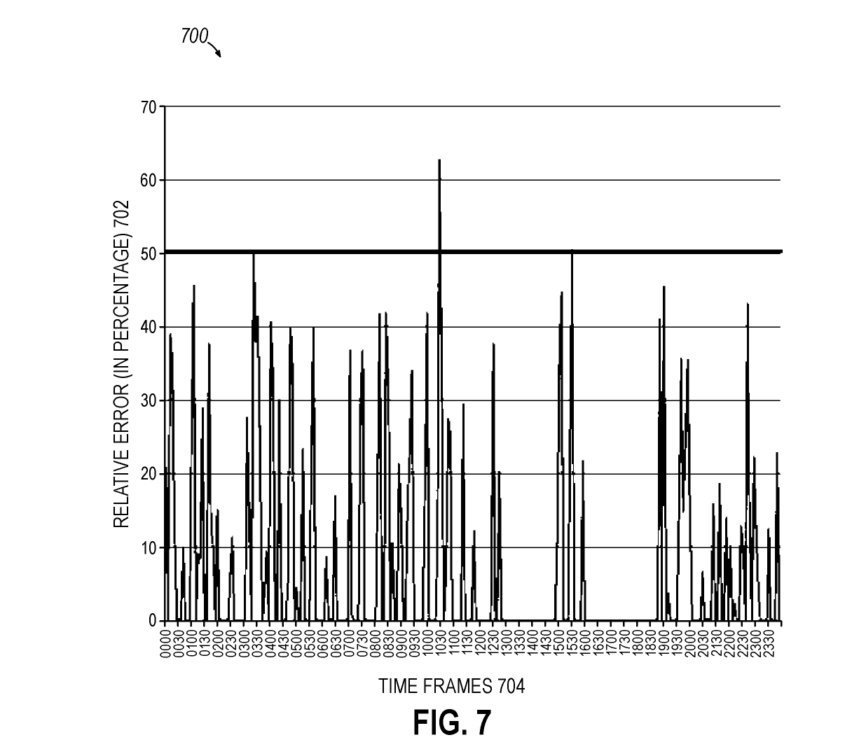

A number of false alarms for the second forecast may occur at time frames where the absolute number of passengers is low, thereby leading to higher percentage relative error even for small difference values between the forecast value and the actual value of passenger flow. To avoid such false alarms, the system 100 may ignore forecast passenger values that are below a predetermined threshold, for example, 50 passengers. A plot of relative errors as a result of such filtering is illustrated in FIG. 7. The plot 700 shows percentage relative error (702) of the second forecast plotted against time frames (704).

Latency may be introduced to decrease the predetermined threshold to less than 50% and to decrease the false positive alarms. In the current example, alarm may be raised only when the relative error of the second forecast exceeds the predetermined threshold for two (2) consecutive time frames. The trade-off of using the latency is that alarm may not be raised immediately, but raised with a delay of 2N minutes (when the latency of two time frames is used).

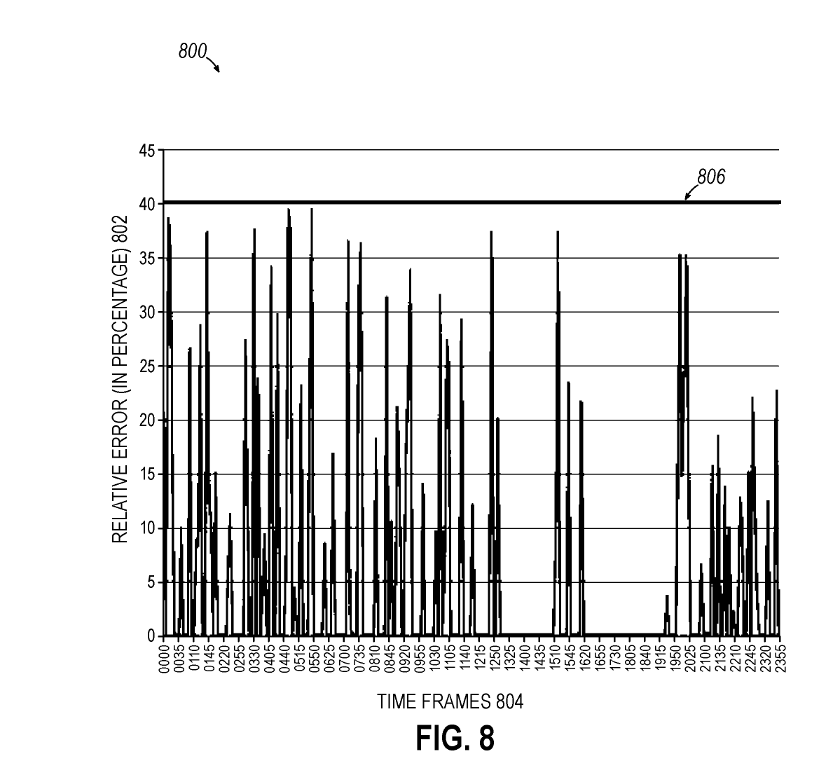

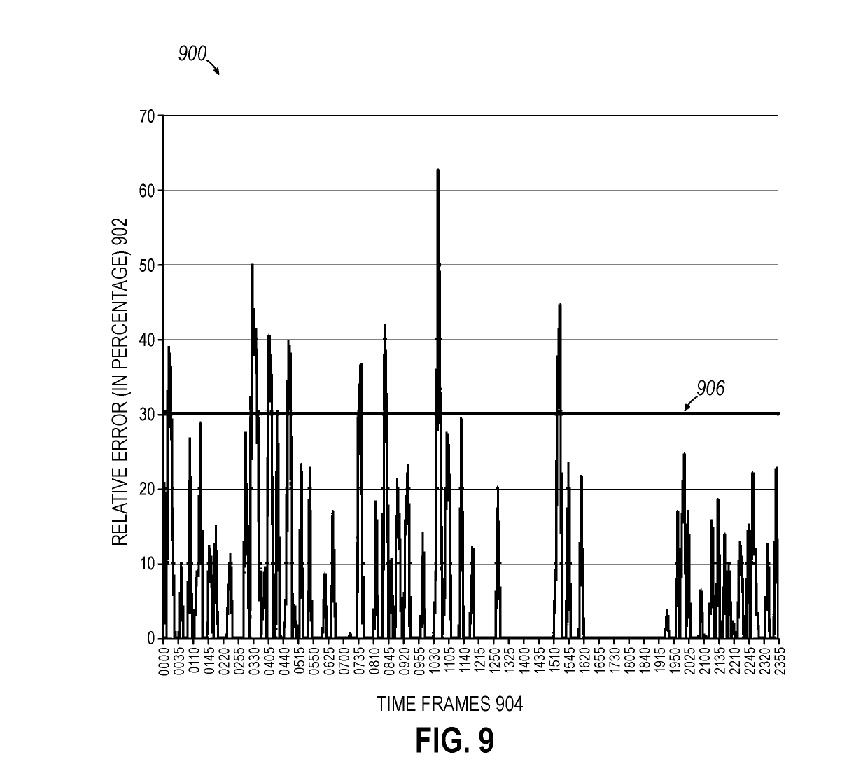

FIG. 8 illustrates a plot 800 of relative error 802 versus time frames 804 for the predetermined threshold 806 reduced to 40% and the latency of two frames. FIG. 9 illustrates a similar plot 900 of relative error 902 versus time 904 with the predetermined threshold further reduced to 30%. The latency is kept the same.

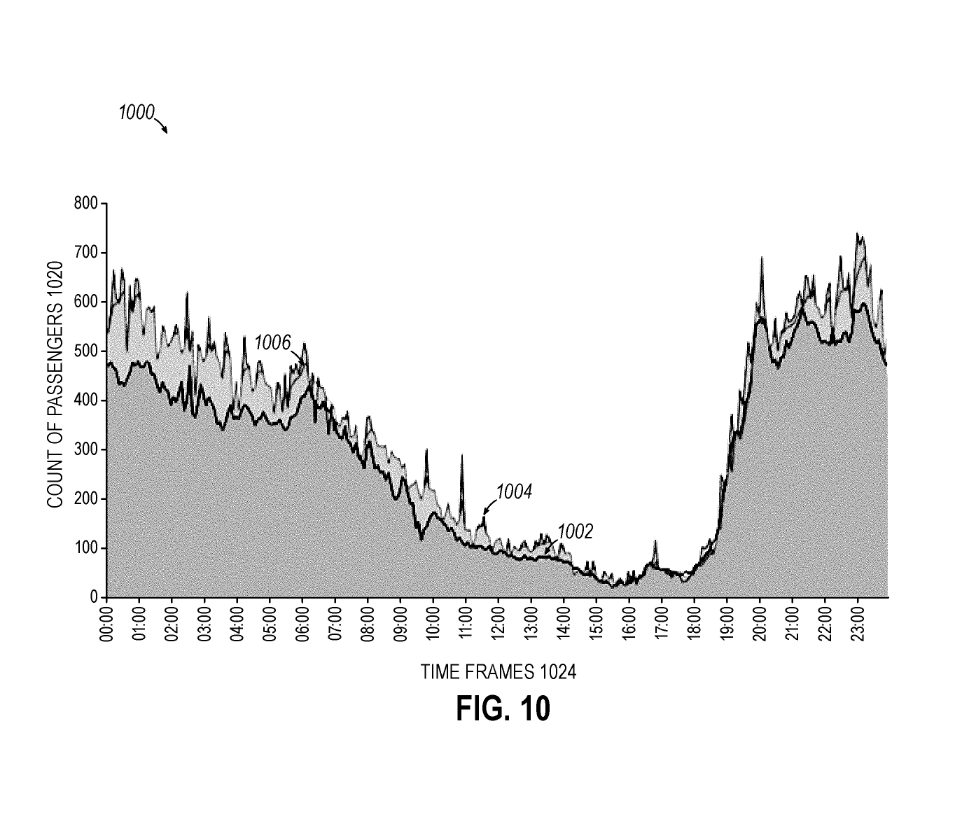

The forecasting engine 102 generates the forecast passenger flow value by combining the first forecast and the second forecast for the target time frame. The combination also includes computing a relative error for the first and second forecasts and keeping the forecast with the smaller relative error. FIG. 10 illustrates a plot 1000 of the first forecast 1002, the second forecast 1004 and the optimized forecast 1006 generated by combining the first forecast 1002 and the second forecast 1004. The rolling moving average technique provides a smooth forecast that decreases and increases slowly. The Holt-Winters technique provides a forecast that is highly reactive to changes. The combination of the rolling average technique and the Holt-Winters double exponential smoothing technique provides a forecast that is reactive to recovery and slightly sensible to a defect.

The optimized value that is used is, for a given interval, the value between the real value or the rolling moving average that best approximates to the forecasted value, i.e., the one with minimum relative error to the forecasted value. So in some cases the optimized value will correspond to the real value, and in some cases it will correspond to the rolling moving average. A reason for this approach, is that taking the minimum relative error from the real value or the rolling moving average to the forecasted value means that the system is less sensitive to partial drop downs (rolling moving average drops slower than real value) but more sensitive to recoveries (real values climbs up faster than rolling moving average). The inventors have found that this is particularly effective for monitoring passenger flows at such a little interval of five minutes, as it adds the daily trend dimension over the real measured values.

Although, the above example is discussed for the passenger flow at boarding, one should appreciate that the technique described above can be used for the passenger flows at check-in, or a combination of the two.

The system and method disclosed in the present disclosure may be implemented or used in transport sectors such as, but not limited to, airports, train stations, bus stations, and shipping. The system and method include computing a first forecast on the basis of the passenger flow in a first set of the time frames directly preceding the target time frame. The system and method may further include computing a second forecast on the basis of the passenger flow in a second set of the time frames. The second set of time frames having occurred on a same weekday and at a same time as the target time frame, in weeks preceding the target time frame. The system and method include combining the first and second forecasts.

Each computing system described herein, also referred to as a platform, client, server, engine, unit, or back end, may include at least one processing unit configured to execute one or more instructions to perform one or more operations consistent with embodiments of the invention. Each computing system generally includes an input/output (“I/O”) interface, a display, and external devices. The I/O interface may be configured to receive data from the display and data from the external devices that is communicated to the processing unit and may be configured to output data from the processing unit to the display and external devices. The display may be, for example, a computer monitor or a screen on a mobile phone or a tablet. Alternatively, the display may be a touch screen that not only functions to permit a user to receive and view output data, but also functions to permit the user to input data with, for example, an onscreen virtual keyboard. The external devices may include, for example, additional user input devices such as a keyboard, a keypad, a mouse, a microphone, etc., and additional user output devices such as speakers, etc. The computing system may also include a network adapter, such as a network interface card or a transceiver, that supplies the physical connection with a network and that is configured to transmit data and receive over the network.

Each computing system includes a memory configured to store one or more software modules or applications and/or an operating system, where each application and the operating system each generally comprise one or more instructions stored as program code that may be read from the memory by each processing unit. The instructions, when executed by the processing unit, may cause the processing unit to perform one or more operations to thereby perform the steps necessary to execute steps, elements, and/or blocks embodying the various embodiments of the invention.

The memory may represent random access memory (RAM) comprising the main storage of a computer, as well as any supplemental levels of memory, e.g., cache memories, non-volatile or backup memories (e.g., programmable or flash memories), mass storage memory, read-only memories (ROM), etc. In addition, the memory may be considered to include memory storage physically located elsewhere, e.g., cache memory in a processor of any computing system in communication with the client device 16, as well as any storage device on any computing system in communication with the client device 16 (e.g., a remote storage database, a memory device of a remote computing device, cloud storage, etc.).

The routines and/or instructions that may be executed by the one or more processing units to implement embodiments of the invention, whether implemented as part of an operating system or a specific application, component, program, object, module, interface, engine element, tool, or sequence of operations executed by each processing unit, will be referred to herein as “program modules”, “computer program code” or simply “modules” or “program code.” Generally, program modules may include routines, programs, objects, components, logic, data structures, and so on that perform particular tasks or implement particular abstract data types. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. Given the many ways in which computer code may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The flowcharts, block diagrams, and sequence diagrams herein illustrate the architecture, functionality, and operation of possible implementations of systems, methods, and computer program products according to various embodiments of the present invention. In this regard, each block in a flowchart, block diagram, or sequence diagram may represent a segment or portion of program code, which comprises one or more executable instructions for implementing the specified logical function(s) and/or act(s). Program code may be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the blocks of the flowcharts, sequence diagrams, and/or block diagrams herein. In certain alternative implementations, the functions noted in the blocks may occur in a different order than shown and described. For example, a pair of blocks described and shown as consecutively executed may be instead executed concurrently, or the two blocks may sometimes be executed in the reverse order, depending upon the functionality involved. Each block and combinations of blocks can be implemented by special purpose hardware-based systems that perform the specified functions or acts, or combinations of special purpose hardware and computer instructions.

The program code of any of the embodiments described herein is capable of being individually or collectively distributed as a program product in a variety of different forms. In particular, the program code may be distributed using a computer readable media, which may include computer readable storage media and communication media. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

While the invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicants' general inventive concept.

What is claimed is:

1. A method for detecting an anomaly in a passenger flow towards a transport device, the passenger flow representing a number of passengers being handled at a given location per a plurality of time frames each comprised of a plurality of minutes, the method comprising:
aggregating historical data relating to the passenger flow;
computing a first forecast based on the passenger flow in a first set of the time frames of the historical data directly preceding a target time frame;
computing a second forecast on the basis of the passenger flow in a second set of the time frames of the historical data, the second set of time frames having occurred on a same weekday and at a same time as the target time frame over a plurality of weeks preceding the target time frame; and
combining the first and second forecasts to determine a forecast passenger flow value for the target time frame.

2. The method of claim 1, wherein the first set of time frames comprises at least three time frames that are directly preceding the target time frame and wherein the first forecast is computed as a rolling moving average of the passenger flow in the at least three time frames of the first set.

3. The method of claim 1, wherein the second set of time frames comprises at least three time frames that have occurred on the same weekday and at the same time as the target time frame in the weeks preceding the target time frame and wherein the second forecast is computed by exponential smoothing of the passenger flow in the at least three time frames of the second set.

4. The method of claim 3, wherein the exponential smoothing comprises double exponential smoothing.

5. The method of claim 3, wherein the exponential smoothing comprises Holt-Winters double exponential smoothing.

6. The method of claim 1, wherein the combination comprises computing a relative error for the first and second forecasts and keeping the forecast with the smaller relative error.

7. The method of claim 1, wherein the plurality of minutes is less than or equal to 10 minutes.

8. The method of claim 1, wherein the plurality of minutes is greater than or equal to 1 minute.

9. The method of claim 1, further comprising:
raising an alarm if the forecast passenger flow value differs by more than a predetermined threshold from an actual passenger flow in the target time frame.

10. The method of claim 9, wherein the predetermined threshold is within a range of 30% to 50%.

11. The method of claim 9, wherein the alarm is not raised if the actual passenger flow in the target time frame is below a given minimum.

12. The method of claim 9, wherein the alarm is only raised if the predetermined threshold is exceeded for a number of consecutive time frames.

13. A system for detecting an anomaly in a passenger flow towards a transport means, wherein the passenger flow is a number of passengers being handled at a given location per a plurality of time frames each comprised of a plurality of minutes, the system comprising:
an aggregation mechanism including a processor configured to aggregate historical data relating to the passenger flow; and
a forecasting mechanism coupled with the aggregation mechanism, the forecasting mechanism including a processor configured to:
compute a first forecast based on the passenger flow in a first set of the time frames of the historical data directly preceding a target time frame,
compute a second forecast on the basis of the passenger flow in a second set of the time frames of the historical data, the second set of time frames having occurred on a same weekday and at a same time as the target time frame over a plurality of weeks preceding the target time frame, and
combining the first and second forecasts to determine a forecast passenger flow value for the target time frame.

14. The system of claim 13, wherein the first set of time frames comprises at least three time frames that are directly preceding the target time frame and wherein the forecasting mechanism is configured for computing the first forecast as a rolling moving average of the passenger flow in the at least three time frames of the first set.

15. The system of claim 13, wherein the second set of time frames comprises at least three time frames that have occurred on the same weekday and at the same time as the target time frame in the weeks preceding the target time frame and wherein the forecasting mechanism is configured for computing the second forecast by exponential smoothing of the passenger flow in the at least three time frames of the second set.

16. The system of claim 15, wherein the exponential smoothing comprises double exponential smoothing.

17. The system of claim 15, wherein the exponential smoothing comprises Holt-Winters double exponential smoothing.

18. The system of claim 13, wherein the forecasting mechanism is configured to determine the forecast passenger flow value by computing a relative error for the first and second forecasts and keeping the forecast with the smaller relative error.

19. The system of claim 13, wherein the plurality of minutes is less than or equal to 10 minute.

20. The system of claim 13, wherein the plurality of minutes is greater than or equal to 1 minute.

21. The system of claim 13, further comprising:
an alarm mechanism configured to raise an alarm if the forecast passenger flow value differs by more than a predetermined threshold from an actual passenger flow in the target time frame.

22. The system of claim 21, wherein the predetermined threshold is within a range of 30% to 50%.

23. The system of claim 21, wherein the alarm is not raised if the actual passenger flow in the target time frame is below a given minimum.

24. The system of claim 21, wherein the alarm is only raised if the predetermined threshold is exceeded for a number of consecutive time frames.
